(19) United States
(12) Patent Application Publication
(10) Pub. No.: US 2014/0178153 A1
(43) Pub. Date: Jun. 26, 2014

(54) Paper sheet having a hinge adjacent to its spine edge, a plurality of the sheets being bound into a book whereby the sheets lay flat when the book opened

(71) Applicant: Harold P. Hocking, Manhattan Beach, CA (US)

(72) Inventor: Harold P. Hocking, Manhattan Beach, CA (US)

(73) Assignee: Bind Basic Products, LLC

(21) Appl. No.: 13/694,654

(22) Filed: Dec. 26, 2012

(51) Int. Cl. B42C 5/00

(52) U.S. Cl. CPC B42C 5/00
USPC 412/6

(57) ABSTRACT

A method for binding a plurality of paper sheets to form a book, grooves being formed in both surfaces of each sheet adjacent the sheet spine. The sheets lay flat when the book is opened.

### BACKGROUND OF THE INVENTION

1. Field of the Invention

The present invention is directed to the modification of a sheet of paper such that a hinge close to the spine of a sheet is created such that after a plurality of the sheets are bound into a book block, the sheets will lay flat upon opening the book. The hinge is achieved by milling two opposing grooves in the paper close to the spine of the book block prior to binding the sheets so that the sheets will have room to open and lay flat.

2. Description of the Prior Art

When making photo books or photo albums, it is preferred that the pages open flat for the best viewing experience. Moreover, in many cases a single image might extend from the page on left side to the page on the right side. To further facilitate this image creation it is necessary to print the image all the way to the gutter of the first page and then seamlessly onto the following page. This printing can be accomplished using currently available photo printing software. The prior art accomplishes this by printing on a single sheet that comprises the left page and the right page. These pages are scored either before or after printing and subsequently need to be adhesively attached back-to-back to a sequence of similar sheets to create a book block. Such a method, for example, is described in U.S. Pat. No. 7,938,062 to Parker et al which describes a method for fastening photos or scored and folded printed sheets by means of pressure activated adhesives pressed together under high pressure using a mechanical press to form a book block.

Another example of a lay-flat book is exemplified in U.S. Pat. No. 5,456,496 to Kadish in which sheets are adhesively bound to a flexible flattened woven tubular ribbon which allows the book block to freely flex when opened. This method works satisfactorily for sheets that are thin and flexible in the region of the spine where they are adhered to the tubular ribbon.

U.S. Pat. No. 5,779,432 to Bermingham describes a soft cover book in which sheets are adhesively bound to a flexible backbone allowing the book block to open flat. As noted in the Kadish patent, sheets or pages need to be thin and flexible to enable the pages to lay flat.

U.S. Pat. No. 7,490,860 to Didde describes a lay-flat bound book wherein a book block is formed using sheets that have been notched along the spine. The sheets are then offset laterally and assembled onto a book block and subsequently bound together using adhesives that penetrate the notches and allow the nested folded sheets to be bound. This method allows sheets to lay flat when opened depending on the thinness of the individual sheets comprising the book block.

U.S. Pat. No. 7,874,780 to Willauer describes a method and apparatus for gluing folded sheets together, back-to-back, to form a book block that lays flat. The folded sheets require a special machine to assemble the book block and a curing time may be required to allow the adhesive to fully activate.

U.S. Pat. No. 8,182,188 to Manico et al is directed to a special cover used to bind together various types of photographic and printed media using adhesives with release liners attached to and associated with the special cover.

There remains a need in the industry for paper that is especially suited for inkjet, laser or offset printing which, after printing, can be readily stapled or clamped together into a book block that will lay flat when opened.

### SUMMARY OF THE PRESENT INVENTION

The present invention provides modified paper sheets having a hinge groove adjacent to the sheet spine and which does not interfere with conventional printing processes. A guide member is provided to align the sheets and the sheets are then bound and covered with a soft or hard cover.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a paper sheet modified in accordance with the teachings of the present invention;

FIG. 2 is an end view of an alignment guide;

FIG. 3 illustrates a plurality of sheets having their hinges aligned prior to staple binding;

FIG. 4 illustrates the alignment guide with sheets offset due to the guide geometry;

FIG. 5 is a perspective view illustrating a book block inserted into the alignment guide;

FIG. 6 illustrates the aligned book block after the sheets are stapled together;

FIG. 7 illustrates the lay-flat attitude of a book block sheet after binding;

FIG. 8 is a close-up view of the book block opened in the center;

FIG. 9 is a close-up view of a book block opened position when in the lay-flat attitude;

FIG. 10 illustrates a groove formed in accordance with the teachings of the present invention;

FIG. 11 is similar to FIG. 8 with hard covers applied to the book block;

FIG. 12 is a more detailed view of FIG. 11; and

FIGS. 13 and 14 illustrate an alternative method for creating the sheet grooves.

### DESCRIPTION OF THE INVENTION

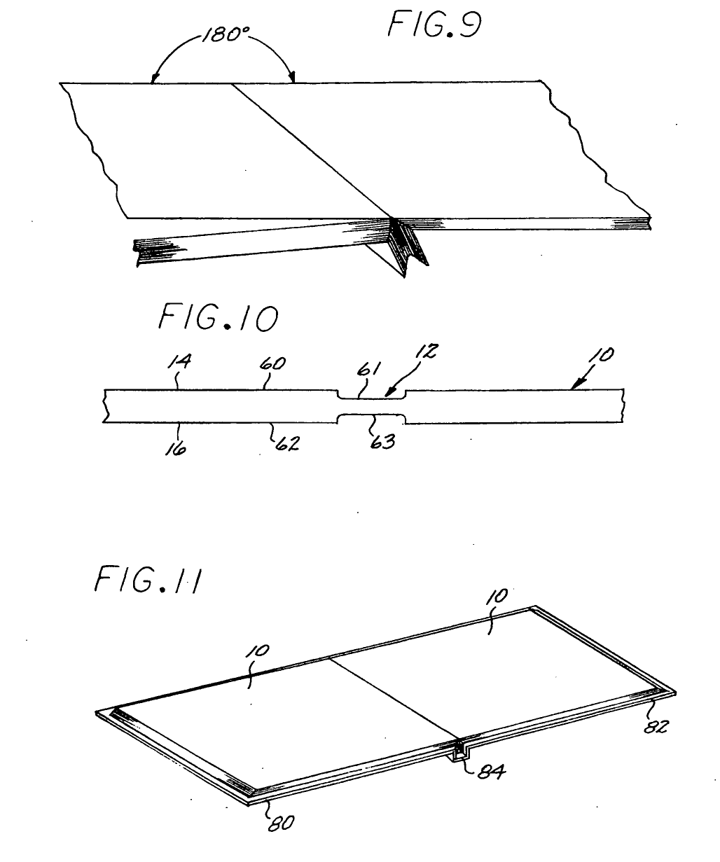

Referring to FIG. 1, a groove 12 is formed in a thick paper sheet 10 on both sides 14 and 16 of paper sheet 10 and aligned exactly opposite to form a double groove 19, the double groove being illustrated in FIG. 10. The grooves are typically formed using a slitting saw blade or grinder. The groove width A ranges from one to three paper thicknesses. For example, a paper having a thickness B of 10-point (0.010 inches), the preferred width B of the groove on both sheet sides 14 and 16 is approximately 0.025 inches (a typical range of sheet thickness is between 0.006 inches (6 point) and 0.014 inches (14 point)). The groove depth C on each sheet side is approximately 25% to 33% of the thickness of the paper. For example, for the same 10-point paper, the depth of the groove on either sheet side would be between 0.002 to 0.003 inches. Note that sheets thinner than the range set forth hereinabove may not require a groove because of their flexibility and thus would not lend themselves to using the technique of the present invention.

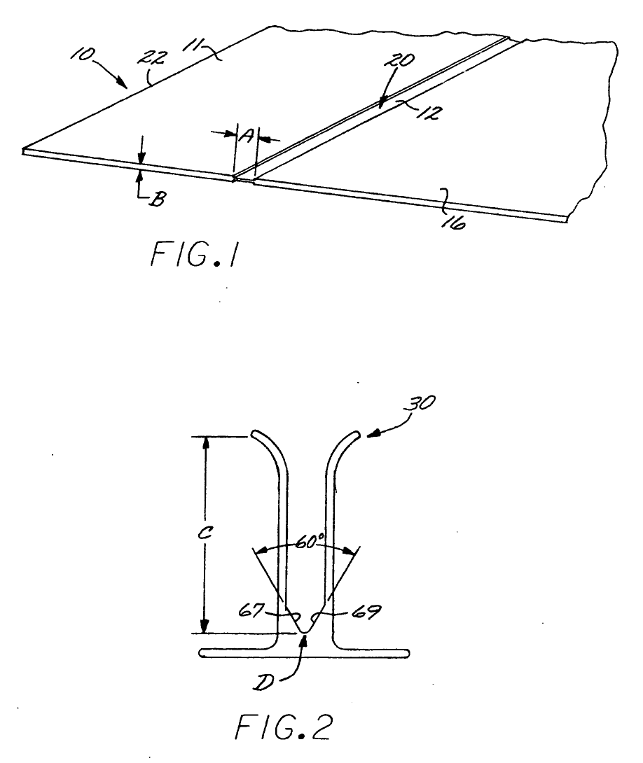

After forming the double groove in sheet 10, the sheet is bent 90 to 180 degrees in both directions causing the fiber remaining in the groove to relax. The double groove 12 is positioned accurately relative to spine edge 22. Typically, the position of the hinge 21 can be fixed on each paper sheet used in the book block 33 (FIG. 4) at, for example, 0.35 inches from the edge 22 of sheet 10. In such a case, a guide 30 (FIG. 2) is used to orient, or align, the sheets of paper relative to each other so that the sheets will have room to open and lay flat after the sheets 10 are bound together. Note that sheets 10 have printed matter formed thereon after the double groove 12 is created, the groove not hindering the printing process.

The double groove geometry consists of grooves 61 and 63 formed on opposing sides 14 and 16, respectively, of each sheet 10 as shown in FIG. 10. As noted hereinabove, the groove depth C on each side is approximately 25% to 33% of the sheet thickness, a 10-point sheet thickness having a groove depth being in the range between 0.002 and 0.003 inches.

The groove is preferably placed 0.35-inches in from the spine edge on all sheets that comprise a book block that is 5/16-inch thick. This position allows room for the staple to be positioned far enough inboard of the spine so as to not break through the offset space in the center of the book block created by the alignment guide and not so far inboard as to interfere with the double grooves. In this case the staple is placed in a region that is 0.20 to 0.27-inches in from the untrimmed edge of the spine.

Other binding methods might dictate that the position of the groove might be different than described above.

The double groove 12 in sheet 10 provides a more flexible region in thick sheets, allowing each sheet to bend or flex in that particular region rather than elsewhere and, in essence, functions as a hinge.

As noted hereinabove, the width A of the grooves ranges between one to three sheet thickness; a sheet having a thickness of 10-point (0.010 inches) B resulting in groove widths A of approximately 0.020 to 0.030 inches.

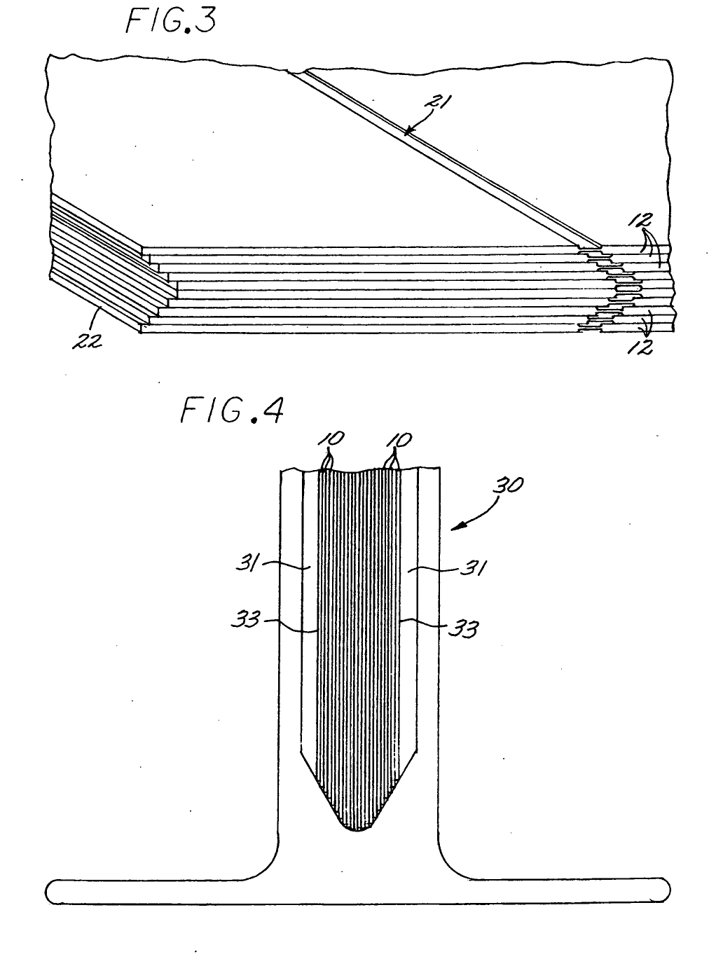

Prior to binding the sheets using the stapling or a clamping method, such as Channel Binding or Velo Binding, the sheets are offset laterally from each other by a distance greater than the thickness of the paper sheet. (The Channel Bind system is well known in the industry and consists of a steel channel that is placed over the end of the spine and a clamping tool is used to deform the metal channel squeezing it against the sides of the book block along the spine edge. The VeloBind system is also well known in the industry and consists of plastic rods that are placed through punched holes close to the edge of the spine. A clamping tool is used to cut and heat stake rods to fit and hold the book block together). A 60 degree included angle of the guide 30 insures that this offset takes place. The surfaces 67 and 69 of guide 30 are preferably formed at an angle of 60 degrees between the surfaces. The offsetting of sheets 10 continues in one direction until the midpoint of the stack and then reverses direction for the remainder of the stack as shown in FIGS. 2 and 3. A radius D of approximately 0.006 inch provides a transition in the center of the document as the direction is reversed. This offset pattern allows the individual sheets to have room to wrap around the adjacent sheets when the book is opened up thus and thus lay flat. Guide 30 is preferably fabricated from aluminum although other materials can be used. Note that the sheet off set is an optimal lateral distance that the sheets (and thereby the groove hinges) are offset so that the sheets of the bound book block will have space to open and lay flat, not interfering with each other. The alignment guide is so designed so as to provide this optimal alignment.

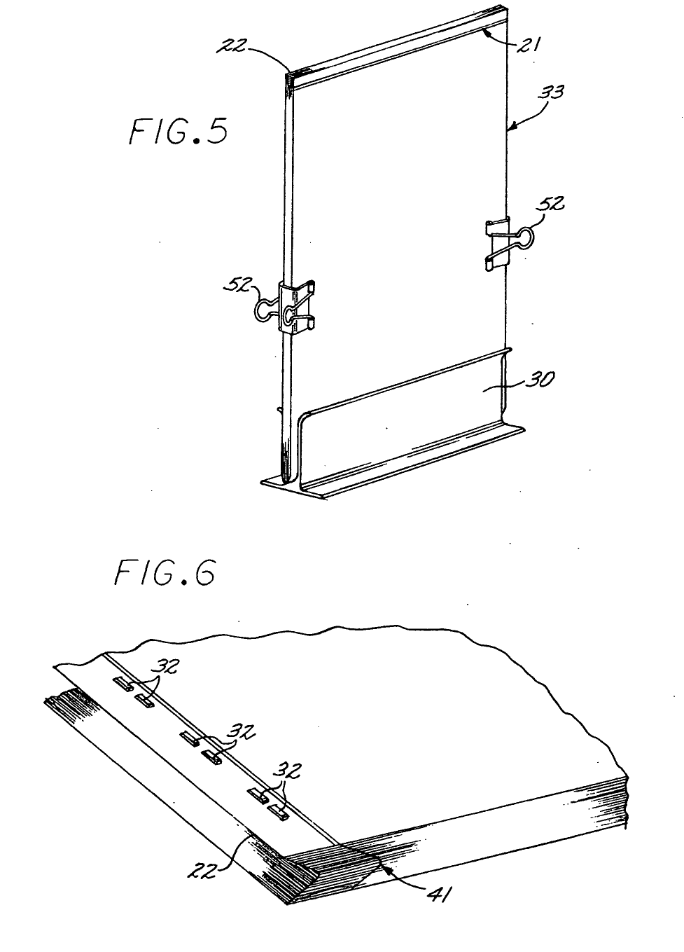

FIG. 4 illustrates guide 30 aligning the plurality of sheets 10 into a book block 50. The sheets 10 are placed into the guide channel 31 of guide 30 with the ends of the sheets 10 that are opposite to the grooves 12 inserted first (the edge of the book block opposite the spine). Clamps 52 (FIGS. 5 and 11) are placed on both sides of the book block 33 perpendicular to the alignment channel prior to removing the book block 33 from guide 30 thus holding the book block in the aligned position while in transition to the binding device. The binding device may comprise a stapler (not shown) which places staples 32 along the spine edge 22 of book block 33 in between the edge 22 of the paper sheet and hinge 20 as shown in FIGS. 6 and 11. Books or photo books are created with this method up to a maximum thickness of approximately 5/16 inch or 0.31 inches. For most common stapling machines, this is the maximum thickness for which the staples will function. After stapling the sheets, the clamps 52 are removed and the ends of the book block 33 are trimmed to remove the offset edges of the book block, forming square ends.

Covers are subsequently applied to book block 33. Typically, a hard cover is applied to the book block, the cover having a pressure sensitive material applied to the inside of both the front and back covers that adheres directly to the end of the outermost sheets.

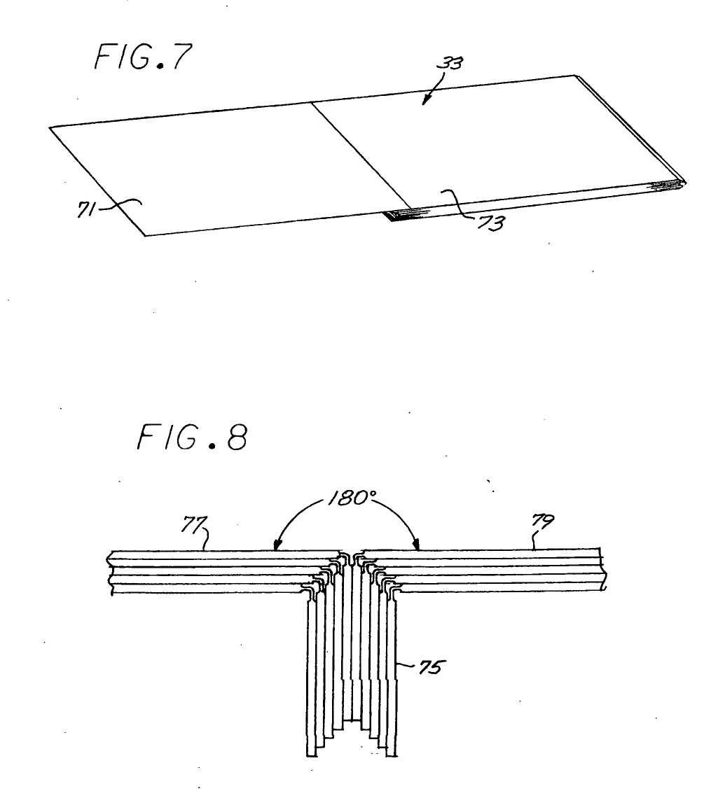

FIG. 7 illustrates the lay-flat position of the first page of book block 33 after the binding operation, block 33 having a cover 71 secured to sheet 73 thereof.

FIG. 8 is a close-up view of book block 33 opened in the center (middle) showing the offset sheets 75 and the remaining sets of sheets 77 and 79 being offset approximately 180 degrees from each other.

FIG. 9 is a close-up view of book block 33 in the ¾ opened position while in the lay-flat mode.

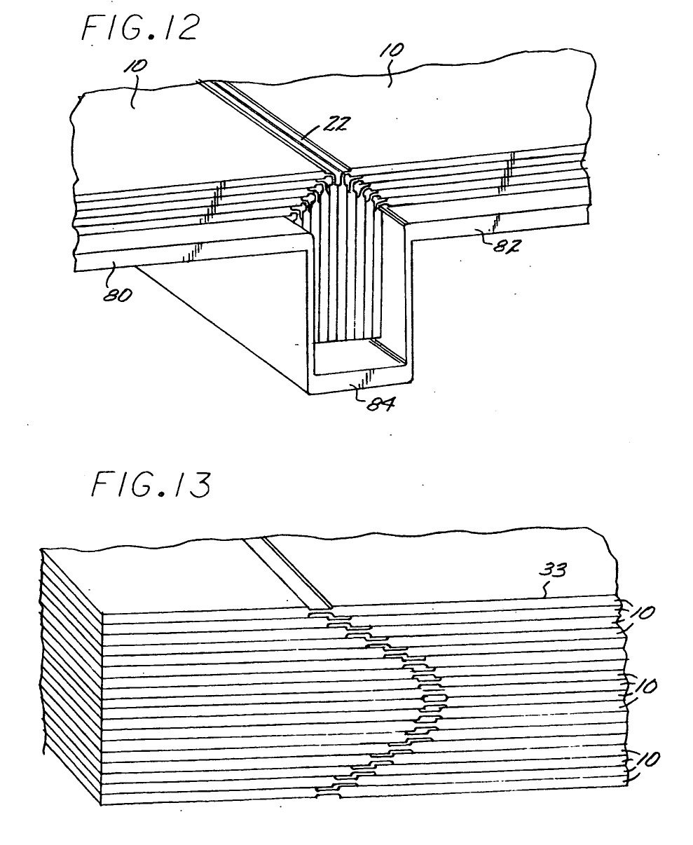

FIG. 10 shows the double groove formed in sheets 10. FIGS. 11 and 12 are typical edge views of sheets 10 with the offset grooves having positions based on their relative position within the book block 33.

FIG. 11 is a perspective view showing the book block 33 in the lay-flat position with hard covers 80 and 82 open in the center. Book spine 84 is also shown.

FIG. 12 is a more detailed view of FIG. 11.

An alternative method for offset aligning the sheets is to create the groove pattern while the sheets are being processed through the grooving machine (the resulting sheets are shown in FIGS. 13 and 14). The position of the groove relative to the spine edge can be indexed automatically for each sheet comprising a book block. Variables of paper thickness and number of sheets comprising the book block are entered into the controller of the grooving machine prior to beginning the job of grooving the sheets. The grooving machine will then place the hinge groove in the appropriate position relative to the spine edge based on these variables, each sheet having the groove uniquely positioned based on its position in the book block. Each book block being processed in this way can be separated in the stacking module with a separator sheet of paper or offset to keep them separate. Book blocks created in this manner can then be stapled or clamped eliminating the need to align the sheets using the guide or to trim the ends of the sheets after binding. Covers are subsequently applied to the book blocks created in this manner. It is common practice to apply a hard cover to the book block using a cover with pressure sensitive adhesive applied to the inside front and inside back covers that adheres directly to the end leaf.

The alternative process of grooving the sheets in preset blocks of sheets is shown in FIGS. 13 and 14. The position of the grooves in the book block after processing by the grooving machine is staggered automatically based on the number and thickness of the sheets.

In summary, the process for forming the book block of the present invention is as follows: Normally pre-grooved sheets will be printed on both sides then accumulated into a book block. End leaves will then be added to the front and back of the book block providing an unprinted surface for the adhesive cover to fasten to. The book block will then be placed into the alignment guide, spine edge up, where each sheet will be positioned giving room for subsequently lay-flat opening of the book. Clamps are then applied to the sides of the book block. The clamped book block is then removed from the guide and staples are applied along the spine edge of the book block. The staples are positioned approximately ¼-inch in from the spine and at multiple locations along the spine edge separated by approximately an inch.

After binding, the spine and the open edges of the book block will be trimmed using a guillotine cutter to square up these edges removing the effects of the alignment guide. A hard cover having a pressure sensitive adhesive o the inside surface of the front and rear covers can then be applied to the end leaves bound to the book block.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method for making a book comprised of a plurality of paper sheets, each sheet having a first and second surface and a spine comprising the steps of:
forming a groove on said first and second sheet surfaces near the sheet spine; and
binding said sheets together to form said book, each sheet, when opened, laying substantially flat upon adjacent sheets.

2. The method of claim 1 further including the step of providing a guide to offset the position of the sheets relative to each other prior to binding.

3. The method of claim 2 further including the step of placing said book into said guide, the sides of said book being fastened to maintain the offset alignment of the sheets while said book is being formed.

4. The method of claim 3 including the step of binding said book.

5. The method of claim 4 wherein said book is bound using staples.
